(19) United States
(12) Patent Application Publication
(10) Pub. No.: US 2017/0365238 A1
(43) Pub. Date: Dec. 21, 2017

(54) Electric Guitar Strings of Magnetic Copper Alloys

(71) Applicant: Materion Corporation, Mayfield Heights, OH (US)

(72) Inventor: Ryan C. Elliott, Mayfield Heights, OH (US)

(21) Appl. No.: 15/622,582

(22) Filed: Jun. 14, 2017

Related U.S. Application Data
(60) Provisional application No. 62/350,828, filed on Jun. 16, 2016.

(51) Int. Cl. G10D 3/10; G10D 1/00; C22F 1/08; C22F 1/00; C22C 9/06; G10H 3/18; C22C 9/05

(52) U.S. Cl. CPC G10D 3/10; G10H 3/18; G10D 1/005; C22C 9/05; C22F 1/002; C22C 9/06; C22F 1/08

(57) ABSTRACT

Guitar strings made of a magnetic copper-nickel-tin-manganese alloy are disclosed. Also disclosed are processing steps that can be performed to fabricate the guitar strings from the alloy. Further described herein are alternative uses for the strings on other electric stringed instruments.

This application claims priority to U.S. Provisional Application Ser. No. 62/350,828, filed Jun. 16, 2016, the entirety of which is fully incorporated herein by reference.

### BACKGROUND

The present disclosure relates to magnetic copper-based alloy guitar strings. In particular, these guitar strings are meant for use with electric guitars. However, it is to be appreciated that the present disclosure is also amenable to other like applications, such as applicability to other chordophone, or stringed, instruments.

Electric guitar strings contain a magnetic material which interacts with the magnetic field of a pickup transducer. When the guitar strings vibrate, they alter the magnetic field of the pickup and an electric signal is produced.

Acoustic guitar strings are commonly made of non-magnetic copper wrapped around a steel core. While the steel component would interact with a magnetic field, the sound from an acoustic guitar is instead derived from the copper component when the string vibrates. Copper-based strings provide a unique tone when they vibrate, which cannot be replicated with electric guitar strings as they currently exist, since copper does not interact strongly with magnetic fields.

It would be desirable to provide magnetic copper-based alloy guitar strings that can produce a fuller and warmer sound than conventional nickel or stainless steel strings on an electric guitar.

### BRIEF DESCRIPTION

The present disclosure is directed to magnetic copper alloy guitar strings. These magnetic copper alloy guitar strings can be made by processing a copper alloy under certain conditions to obtain magnetic properties, and coating or winding the resulting magnetic copper alloy around a core material. The present disclosure is also directed to an electric guitar equipped with these magnetic copper alloy guitar strings.

These and other non-limiting characteristics of the disclosures are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a longitudinal cross-section of a roundwound guitar string.

FIG. 2 is a longitudinal cross-section of a flatwound guitar string.

FIG. 3 is a longitudinal cross-section of a halfwound guitar string.

FIG. 4 is a perspective cross-section of a guitar string formed from a core that is coated with the magnetic copper alloy.

FIG. 5 is an electric guitar equipped with magnetic copper alloy strings.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

The present disclosure may refer to temperatures for certain process steps. It is noted that these generally refer to the temperature at which the heat source (e.g. furnace, oven) is set, and do not necessarily refer to the temperature which must be attained by the material being exposed to the heat.

The present disclosure relates to guitar strings made from a magnetic Cu—Ni—Sn—Mn alloy. The guitar strings include a core and the magnetic alloy that covers the core. In some embodiments, the magnetic copper alloy is formed as a thin strand that is wound around the core to form the guitar string. The core can comprise steel, high carbon steel, tin plated steel, or stainless steel. The magnetic copper alloy can be considered a “shell” or a “sheath” surrounding or encasing the core. These musical instrument strings containing the magnetic copper alloy may be utilized in other electric chordophone, or stringed instrument, applications. Examples of chordophone instruments include violins, mandolins, cellos, lyres, harps, banjos, ukuleles, and pianos. The guitar string may have a total diameter from about 0.005 millimeters to about 1.5 millimeters.

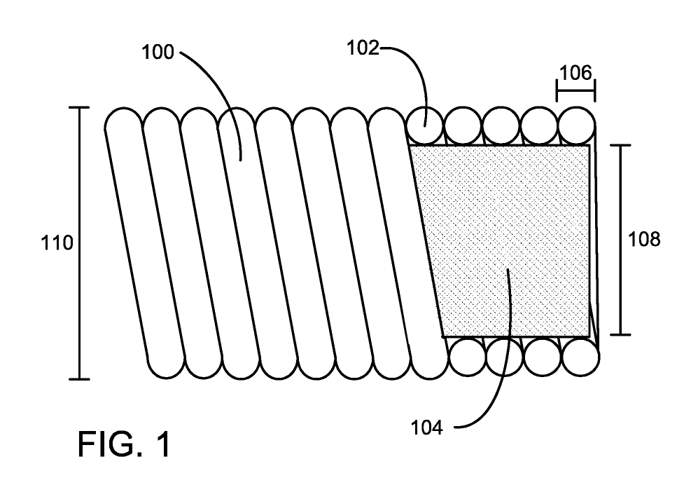

With reference to FIG. 1, in some embodiments, the Cu—Ni—Sn—Mn alloy strand 102 is wound around the core 104 in a manner which results in a roundwound wrap guitar string 100. A roundwound guitar string 100 is a string wherein the outer strand is a cylindrical wire wrapped around the core material, as illustrated in the cross section diagram. In particular embodiments, the ratio of the diameter 108 of the core material to the diameter 106 of the strand is 3:1 or more. The diameter 110 of the guitar string is from about 0.005 millimeters to about 1.5 millimeters.

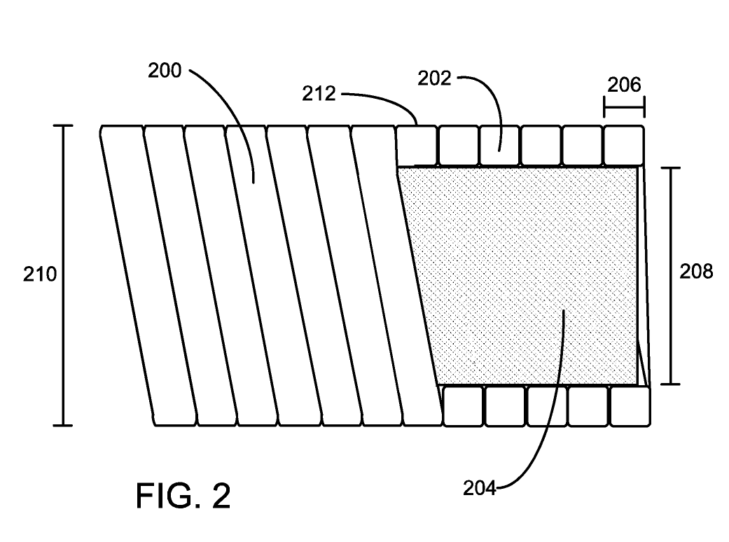

With reference to FIG. 2, in other embodiments, the Cu—Ni—Sn—Mn alloy strand 202 is wound around the core 204 in a manner which would result in a flatwound wrap guitar string 200. A flatwound guitar string 200 is a string wherein the strand has a rounded-square edge 212, and the strand 202 is wrapped around the core material 204, as illustrated in the cross section diagram. The ratio of the diameter 208 of the core material to the diameter 206 of the strand is 3:1 or more. The diameter 210 of the guitar string is from about 0.005 millimeters to about 1.5 millimeters.

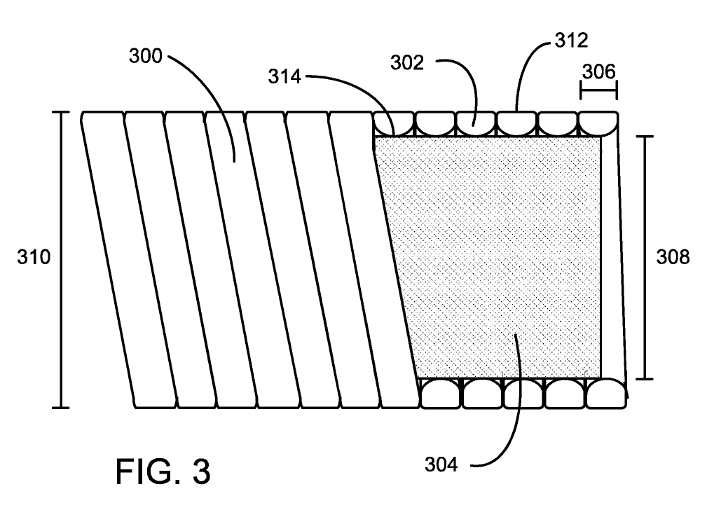

With reference to FIG. 3, in still other embodiments, the Cu—Ni—Sn—Mn alloy strand 302 is wound around the core 304 in a manner which would result in a halfwound wrap guitar string 300. A halfwound guitar string 300 is a string wherein at the beginning of processing, the outer strand is a cylindrical wire which is first wrapped around the core material 304, and subsequently grinded or pressed such that the outward-facing edge 312 of the string becomes flat, while the inward-facing edge 314, contacting the core material 304 of the string 300, remains rounded, as illustrated in the cross section diagram. The ratio of the diameter 308 of the core material to the diameter 306 of the strand is 3:1 or more. Please note the diameter 306 of the strand is measured prior to its being flattened. The diameter 310 of the guitar string is from about 0.005 millimeters to about 1.5 millimeters.

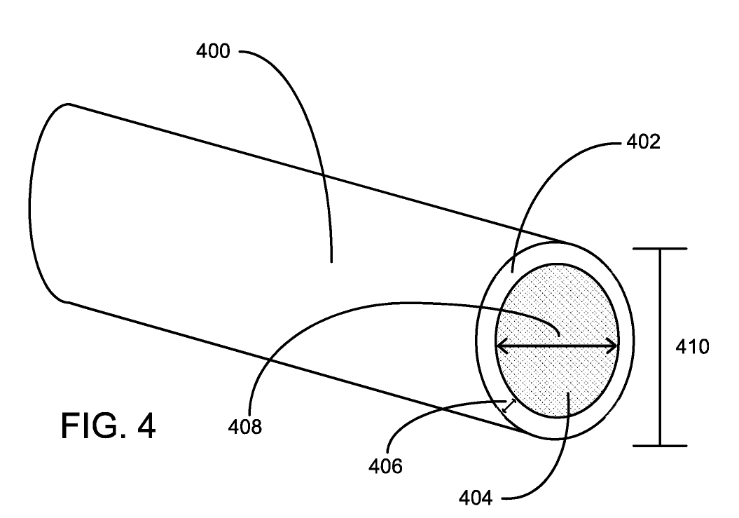

With reference to FIG. 4, in other embodiments, the Cu—Ni—Sn—Mn alloy guitar string 400 is applied to the core 404 in a manner which would result in a uniform coating 402 of the core material by the magnetic copper alloy, as illustrated in the cross section diagram. The ratio of the diameter 408 of the core material to the thickness 406 of the coating is 3:1 or more. The diameter of the guitar string 410 is from about 0.005 millimeters to about 1.5 millimeters. It is noted that as best seen here, the guitar string has a circular cross-section when viewed normal to its longitudinal axis. In addition, it is generally contemplated that the guitar string has only two layers, the core and the layer formed by the magnetic copper alloy, with the alloy layer forming the exterior of the guitar string.

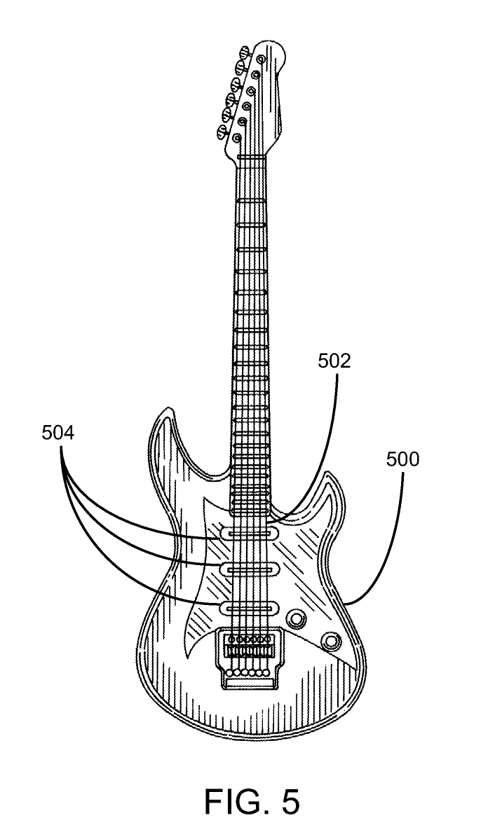

Finally, FIG. 5 illustrates an electric guitar 500 equipped with at least one pickup transducer 504 and the Cu—Ni—Sn—Mn alloy guitar strings 502 herein presented.

Generally, any electric chordophone can be equipped with the magnetic copper alloy strings herein discussed. Such chordophone instruments are equipped with at least one pickup transducer, which converts mechanical vibrations of the string into an electrical signal by detecting alterations within the magnetic field of the transducer. The signal may be amplified, resulting in sound produced by the vibrations. Such instruments can be referred to as “electric.” Conversely, an acoustic instrument lacks a transducer, and produces sound by transmitting the sound waves from the mechanical vibrations of the strings to the air. The magnetic copper-coated guitar strings provide a different sound from conventional electric guitar strings due to the presence of the magnetic copper alloy, which changes the magnetic field and the resulting signal produced by the electric guitar.

The copper-nickel-tin-manganese (Cu—Ni—Sn—Mn) alloys used to coat the core material of the guitar string are both magnetic and electrically conductive. The nickel may be present in an amount of from about 8 wt % to about 16 wt %. In more specific embodiments, the nickel is present in amounts of about 14 wt % to about 16 wt %, about 8 wt % to about 10 wt %, or about 10 wt % to about 12 wt %.

The tin may be present in an amount of from about 5 wt % to about 9 wt %. In more specific embodiments, the tin is present in amounts of about 7 wt % to about 9 wt %, or about 5 wt % to about 7 wt %.

The manganese may be present in an amount of from about 1 wt % to about 21 wt %. In more specific embodiments, the manganese is present in amounts of at least 4 wt %, at least 5 wt %, about 4 wt % to about 12 wt %, about 5 wt % to about 21 wt %, or about 19 wt % to about 21 wt %.

The balance of the alloy is copper. The alloys may further include one or more other metals such as chromium, silicon, molybdenum, or zinc in minor amounts. However, the copper-nickel-tin-manganese alloys do not contain any iron, or in other words iron is only present as an unavoidable impurity, and its presence is not desired in the alloys of this disclosure. For purposes of this disclosure, the copper-nickel-tin-manganese alloys will be considered to contain no iron if the amount of iron is 0.5 wt % or less of the alloy.

In some specific embodiments, the copper-nickel-tin-manganese alloy contains from about 8 wt % to about 16 wt % nickel, about 5 wt % to about 9 wt % tin, about 1 wt % to about 21 wt % manganese, and balance copper.

In other specific embodiments, the copper-nickel-tin-manganese alloy contains from about 8 wt % to about 16 wt % nickel, about 5 wt % to about 9 wt % tin, about 5 wt % to about 21 wt % manganese, and balance copper.

In different embodiments, the copper-nickel-tin-manganese alloy contains from about 8 wt % to about 16 wt % nickel, about 5 wt % to about 9 wt % tin, about 5 wt % to about 11 wt % manganese, and balance copper.

In yet additional embodiments, the copper-nickel-tin-manganese alloy contains from about 8 wt % to about 16 wt % nickel, about 5 wt % to about 9 wt % tin, about 5 wt % to about 11 wt % manganese, and balance copper.

In more specific embodiments, the copper-nickel-tin-manganese alloy contains from about 14 wt % to about 16 wt % nickel, about 7 wt % to about 9 wt % tin, about 1 wt % to about 21 wt % manganese, and balance copper.

In more specific embodiments, the copper-nickel-tin-manganese alloy contains from about 14 wt % to about 16 wt % nickel, about 7 wt % to about 9 wt % tin, about 4 wt % to about 12 wt % manganese, and balance copper.

In other specific embodiments, the copper-nickel-tin-manganese alloy contains from about 8 wt % to about 10 wt % nickel, about 5 wt % to about 7 wt % tin, about 1 wt % to about 21 wt % manganese, and balance copper.

In other specific embodiments, the copper-nickel-tin-manganese alloy contains from about 8 wt % to about 10 wt % nickel, about 5 wt % to about 7 wt % tin, about 4 wt % to about 21 wt % manganese, and balance copper.

In a few specific embodiments, the copper-nickel-tin-manganese alloy contains from about 10 wt % to about 12 wt % nickel, about 5 wt % to about 7 wt % tin, about 1 wt % to about 21 wt % manganese, and balance copper.

These alloys can be formed by adding the manganese to a molten copper-nickel-tin alloy. The preparation of a properly proportioned batch of copper, nickel, and tin is followed by melting to form the alloy. The melting may be carried out in a gas-fired, electrical induction or arc furnace of a size matched to the desired solidified product configuration. Typically, the melting temperature is at least about 2057° F. with a superheat dependent on the casting process and in the range of 150 to 400° F. An inert atmosphere (e.g., including argon and/or carbon dioxide/monoxide) and/or the use of protective covers (e.g., vermiculite, alumina, and/or graphite) may be utilized to maintain neutral or reducing conditions to protect oxidizable elements. Reactive metals such as magnesium, calcium, beryllium, and/or tungsten may be added after initial meltdown to ensure low concentrations of dissolved oxygen. Casting of the alloy may be performed following melt temperature stabilization with appropriate superheat into continuous cast billets, parts, or shot.

In some embodiments, the as-cast alloy is magnetic. In particular, such copper-nickel-tin-manganese alloys may contain from about 2 wt % to about 20 wt % of manganese. Whether the copper-based alloy is magnetic can be determined by a semi-quantitative assessment of the attraction force of the alloy in the presence of a powerful rare earth magnet.

Interestingly, the magnetic and mechanical properties of the as-cast alloy can be changed by additional processing steps. In addition, alloys that were previously magnetic after some processing steps can be rendered non-magnetic by further processing steps, then rendered magnetic again after additional processing. The magnetic property is thus not inherent to the copper-based alloy itself, but is rather affected by the processing that is performed. As a result, one can obtain magnetic alloys with desired combinations of magnetic and strength properties such as relative magnetic permeability, electrical conductivity, and hardness (Rockwell B or C). A customized magnetic response can thus be tailored based on various combinations of homogenizing, solution annealing, aging, hot rolling, cold rolling, extrusion, and hot upsetting. In addition, such alloys should have a relatively low elastic modulus on the order of about 15×10⁶ psi to about 25×10⁶ psi. Thus, good spring characteristics can be achieved by enabling high elastic strains, on the order of 50% higher than otherwise expected from iron-based alloys or nickel-based alloys.

Homogenizing involves heating the alloy to create a homogeneous structure in the alloy to reduce chemical or metallurgical segregation that can occur as a natural result of solidification. Diffusion of the alloy elements occurs until they are evenly distributed throughout the alloy. This occurs at a temperature that is usually between 80% and 90% of the solidus temperature of the alloy. Homogenization improves plasticity, increases stability of mechanical properties, and decreases anisotropy in the alloy.

Solution annealing involves heating the alloy to a high enough temperature to convert the microstructure into a single phase. A rapid quench to room temperature leaves the alloy in a supersaturated state that makes the alloy soft and ductile, helps regulate grain size, and prepares the alloy for aging. Subsequent heating of the supersaturated solid solution causes precipitation of the strengthening phase and hardens the alloy.

Aging is a heat treatment technique that produces ordering and fine particles (i.e. precipitates) of an impurity phase that impedes the movement of defects in a crystal lattice. This hardens the alloy.

Hot rolling is a metal forming process in which an alloy is passed through rolls to reduce the thickness of the alloy and to make the thickness uniform, at a temperature above the recrystallization temperature of the alloy. This generally reduces directionality in mechanical properties, and produces an equiaxed microstructure. The degree of hot rolling performed is indicated in terms of % reduction in thickness, or % reduction in area, and is referred to in this disclosure as merely “% reduction”.

Cold rolling is a metal forming process in which an alloy is passed through rolls to reduce the thickness of the alloy and to make the thickness uniform, at a temperature below the recrystallization temperature of the alloy. This increases the strength of the alloy. The degree of cold rolling performed is indicated in terms of % reduction in thickness, or % reduction in area, and is referred to in this disclosure as merely “% reduction”.

Extrusion is a process in which the alloy of a certain cross-section is forced through a die with a smaller cross-section. This tends to produce an elongated grain structure in the direction of extrusion. The ratio of the final cross-sectional area to the original cross-sectional area can be used to indicate the degree of deformation.

Hot upsetting is a process by which a round section of the alloy is compressed by application of heat and pressure, which expands its diameter (i.e. increases the cross-sectional area). This plastically deforms the alloy, and is performed above the recrystallization temperature. This improves mechanical properties, improves ductility, and refines coarse grains. The percent reduction in thickness is used to indicate the degree of hot upsetting performed.

After some heat treatments, the alloy must be cooled back down to room temperature. This can be done by water quenching, air cooling, or furnace cooling. In particular, furnace cooling permits control of the rate of cooling by stepping the temperature down over time.

In a first set of additional processing steps, after the alloy is cast, the alloy is homogenized for a time period of about 4 hours to about 16 hours at a temperature of about 1400° F. to about 1700° F., and then water quenched. This set of steps generally retains magnetism in alloys that have a manganese content of at least 15 wt %, decreases the relative magnetic permeability, can increase the electrical conductivity, and can change the hardness in either direction as desired. Alloys having a lower manganese content generally become non-magnetic upon this set of additional processing steps.

In some alloys, although the first set of additional processing steps removes magnetism, the magnetism can be regained upon a second homogenizing for a time period of about 8 hours to about 12 hours at a temperature of about 1500° F. to about 1600° F. and then water quenching.

Magnetism can also be retained if, after the homogenizing for a time period of about 4 hours to about 16 hours at a temperature of about 1400° F. to about 1700° F., the alloy is hot upset from about 40% to about 60% reduction, and then water quenched.

In a second set of additional processing steps, after the alloy is cast, the alloy is homogenized for a time period of about 5 hours to about 7 hours at a temperature of about 1500° F. to about 1600° F., and then air cooled. This set of steps can retain magnetism in alloys that have a manganese content of at least 5 wt %, particularly a manganese content of about 10 wt % to about 12 wt %.

Interestingly, the magnetism of some copper alloys that are rendered non-magnetic by the homogenizing step of the second set of additional steps can be made magnetic again by subsequently solution annealing the homogenized alloy for a time period of about 1 hour to about 3 hours at a temperature of about 1400° F. to about 1600° F. and then water quenching; aging the annealed alloy for a time period of about 2 hours to about 4 hours at a temperature of about 750° F. to about 1200° F., and then air cooling. Again, this processing can decrease the relative magnetic permeability, can increase the electrical conductivity, and can change the hardness in either direction as desired. In particular embodiments, the electrical conductivity is increased to about 4% IACS.

In a third set of additional processing steps, after the alloy is cast, the alloy is homogenized for a time period of about 5 hours to about 7 hours at a first temperature of about 1500° F. to about 1600° F. and then air cooled. The alloy is then heated for a time period of about 1 hour to about 3 hours at a temperature of about 1500° F. to about 1600° F. (which is usually lower than the homogenization temperature), then hot rolled a first time. If needed, the alloy is reheated for a time period of about 5 minutes to about 60 minutes at a temperature of about 1500° F. to about 1600° F., and then hot rolled a second time to achieve a total reduction of about 65% to about 70%. Finally, the alloy is solution annealed for a time period of about 4 hours to about 6 hours at a temperature of about 1500° F. to about 1600° F.; and then cooled by either furnace cooling or water quenching. This set of steps can retain magnetism in alloys that have a manganese content of at least 5 wt %, as well as those having a manganese content of about 4 wt % to about 6 wt %.

After the homogenizing, hot rolling, and solution annealing described in the third set of additional processing steps, the alloy can also be aged for a time period of about 1 hour to about 24 hours at a temperature of about 750° F. to about 850° F. and then air cooled, and still remain magnetic.

In a fourth set of additional processing steps, after the alloy is cast, the alloy is homogenized for a time period of about 4 hours to about 22 hours at a temperature of about 1200° F. to about 1600° F. The alloy is then heated for a time period of about 1 hour to about 3 hours at a temperature of about 1400° F. to about 1600° F., and then is hot rolled to achieve a reduction of about 65% to about 70%. The alloy is then solution annealed for a time period of about 1 hour to about 3 hours at a temperature of about 1300° F. to about 1600° F. and then water quenching. Copper-nickel-tin-manganese alloys having a manganese content of at least 5 wt % can also retain their magnetism after this fourth set of processing steps, particularly those with a manganese content of about 7 wt % to about 21 wt %, or those having a nickel content of about 8 wt % to about 12 wt % and a tin content of about 5 wt % to about 7 wt %.

After the homogenizing, hot rolling, and solution annealing described in the fourth set of additional processing steps, the alloy can also be aged for a time period of about 2 hours to about 4 hours at a temperature of about 750° F. to about 1200° F. and then air cooled, and retain magnetism. This aging step can also re-activate the magnetism of some alloys that are non-magnetic after the homogenizing, hot rolling, and solution annealing processing steps.

Alternatively, after the homogenizing, hot rolling, and solution annealing described in the fourth set of additional processing steps, the alloy can also be cold rolled to achieve a reduction of about 20% to about 40%, and re-activate magnetism. The combination of the fourth set of additional processing steps with this extra cold rolling step can be considered a fifth set of additional processing steps.

Additionally, after the homogenizing, hot rolling, solution annealing, and cold rolling described in the fifth set of additional processing steps, the alloy can then be aged for a time period of about 2 hours to about 4 hours at a temperature of about 750° F. to about 1200° F., and then air cooled, and re-activate magnetism as well. The combination of the fifth set of additional processing steps with this extra aging step can be considered a sixth set of additional processing steps.

In a seventh set of additional processing steps, after the alloy is cast, the alloy is homogenized for a time period of about 5 hours to about 7 hours at a first temperature of about 1500° F. to about 1600° F. and then air cooled. The alloy is then heated for a second time period of about 6 hours or longer at a temperature of about 1500° F. to about 1600° F. The alloy is then extruded to achieve a reduction of about 80% to about 90%. Copper-nickel-tin-manganese alloys having a manganese content of at least 7 wt % can also retain their magnetism after this seventh set of processing steps, particularly those with a manganese content of about 10 wt % to about 12 wt %.

After the homogenizing and extruding steps described in the seventh set of additional processing steps, the alloy can also be solution annealed for a time period of about 1 hour to about 3 hours at a temperature of about 1200° F. to about 1500° F. and then water quenching. This solution annealing step can also re-activate the magnetism of some alloys that are non-magnetic after the homogenizing and extruding steps.

The resulting magnetic copper-nickel-tin-manganese alloys can thus have different combinations of values for various properties. The magnetic alloy may have a relative magnetic permeability (pr) of at least 1.100, or at least 1.500, or at least 1.900. The magnetic alloy may have a Rockwell hardness B (HRB) of at least 60, at least 70, or at least 80, or at least 90. The magnetic alloy may have a Rockwell hardness C (HRC) of at least 25, at least 30, or at least 35. Various combinations of these properties are contemplated.

In particular embodiments, the magnetic alloy may have a relative magnetic permeability (μᵣ) of at least 1.100, and a Rockwell hardness B (HRB) of at least 60.

In other embodiments, the magnetic alloy may have a relative magnetic permeability (μᵣ) of at least 1.100, and a Rockwell hardness C (HRC) of at least 25.

Other properties, characteristics, compositions, and examples relating to the magnetic copper alloys used to form the outer layer/shell of the guitar string can be found in U.S. patent application Ser. No. 15/074,210, filed Mar. 18, 2016, which is fully incorporated by reference.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A guitar string, comprising a core material encased in a magnetic copper alloy sheath, the magnetic copper alloy comprising nickel, tin, manganese, and balance copper.

2. The guitar string of claim 1, wherein the core material is made of steel, high carbon steel, tin plated steel, or stainless steel.

3. The guitar string of claim 1, wherein a ratio of a diameter of the core material to a diameter of the sheath is 3:1 or more.

4. The guitar string of claim 1, wherein the magnetic copper alloy contains from about 8 wt % to about 16 wt % nickel, about 5 wt % to about 9 wt % tin, and from about 1 wt % to about 21 wt % manganese.

5. The guitar string of claim 1, wherein the magnetic alloy has a manganese content of at least 5 wt % and is formed by:
casting the alloy; and
homogenizing the alloy for a time period of about 4 hours to about 16 hours at a temperature of about 1400° F. to about 1700° F. and then water quenching.

6. The guitar string of claim 5, wherein the alloy is further formed by a second homogenizing for a time period of about 8 hours to about 12 hours at a temperature of about 1500° F. to about 1600° F. and then water quenching.

7. The guitar string of claim 1, wherein the magnetic alloy has a manganese content of at least 5 wt % and is formed by:
casting the alloy; and
homogenizing the alloy for a time period of about 5 hours to about 7 hours at a temperature of about 1500° F. to about 1700° F. and then air cooling.

8. The guitar string of claim 7, wherein the alloy is formed by:
subsequently solution annealing the homogenized alloy for a time period of about 1 hour to about 3 hours at a temperature of about 1400° F. to about 1600° F. and then water quenching; and
aging the annealed alloy for a time period of about 2 hours to about 4 hours at a temperature of about 750° F. to about 1200° F. and then air cooling.

9. The guitar string of claim 1, wherein the magnetic alloy has a manganese content of at least 5 wt % and is formed by:
casting the alloy;
homogenizing the alloy for a first time period of about 5 hours to about 7 hours at a first temperature of about 1500° F. to about 1700° F. and then air cooling;
heating the alloy for a time period of about 1 hour to about 3 hours at a temperature of about 1400° F. to about 1600° F.;
hot rolling the alloy to achieve a reduction of about 65% to about 70%;
solution annealing the alloy for a time period of about 4 hours to about 6 hours at a temperature of about 1400° F. to about 1600° F.; and
cooling the annealed alloy by either furnace cooling or water quenching.

10. The guitar string of claim 9, wherein the alloy is further formed by aging the alloy for a time period of about 1 hour to about 24 hours at a temperature of about 750° F. to about 850° F. and then air cooling.

11. The guitar string of claim 1, wherein the magnetic alloy has a manganese content of at least 5 wt % and is formed by:
casting the alloy;
homogenizing the alloy for a time period of about 4 hours to about 22 hours at a temperature of about 1200° F. to about 1700° F.;
heating the alloy for a time period of about 1 hour to about 3 hours at a temperature of about 1400° F. to about 1600° F. and hot rolling to achieve a reduction of about 65% to about 70%;
solution annealing the alloy for a time period of about 1 hour to about 3 hours at a temperature of about 1200° F. to about 1600° F. and then water quenching.

12. The guitar string of claim 11, wherein the alloy is further treated by aging the alloy for a time period of about 2 hours to about 4 hours at a temperature of about 750° F. to about 1200° F. and then air cooling.

13. The guitar string of claim 11, wherein the alloy is further treated by cold rolling the alloy to achieve a reduction of about 20% to about 40%.

14. The guitar string of claim 1, wherein the magnetic alloy has a manganese content of at least 7 wt % and is formed by:
casting the alloy;
homogenizing the alloy for a first time period of about 5 hours to about 22 hours at a first temperature of about 1200° F. to about 1700° F. and then air cooling;
heating the alloy for a time period of about 4 hours or longer at a temperature of about 1200° F. to about 1600° F.; and
extruding the alloy to achieve a reduction of about 66% to about 90%.

15. The guitar string of claim 14, wherein the alloy is further formed by solution annealing the alloy for a time period of about 1 hour to about 3 hours at a temperature of about 1200° F. to about 1700° F. and then water quenching.

16. The guitar string of claim 1, wherein the alloy is formed by:
casting the alloy;
homogenizing the alloy for a first time period of about 5 hours to about 22 hours at a first temperature of about 1200° F. to about 1700° F. and then air cooling;
heating the alloy for a time period of about 4 hours or longer at a temperature of about 1200° F. to about 1600° F.; and
extruding the alloy to achieve a reduction of about 66% to about 90%;
solution annealing the alloy for a time period of about 1 hour to about 3 hours at a temperature of about 1200° F. to about 1700° F. and then quenching;
optionally cold working the alloy to achieve a reduction of about 20% to about 40%; and
aging the alloy for a time period of about 1 hour to about 4 hours at a temperature of about 600° F. to about 1200° F., and then air cooling.

17. The guitar string of claim 1, wherein the magnetic copper alloy is in the form of a predominantly copper matrix containing nickel, tin, and manganese therein.

18. A process for making a guitar string, comprising:
winding a strand of a magnetic copper alloy around a core material to form a sheath;
wherein the magnetic copper alloy comprises nickel, tin, manganese, and balance copper.

19. A process for making a guitar string, comprising:
coating a core material with a magnetic copper alloy to form a sheath;
wherein the magnetic copper alloy comprises nickel, tin, manganese, and balance copper.

20. An electric stringed instrument equipped with a pickup transducer, wherein the strings comprise a core material encased in a magnetic copper alloy sheath, the magnetic copper alloy comprising nickel, tin, manganese, and balance copper.
